(19) United States
(12) Patent Application Publication
(10) Pub. No.: US 2008/0104573 A1
(43) Pub. Date: May 1, 2008

(54) SOFTWARE BUILD VALIDATION BEFORE CHECK-IN

(75) Inventors: Kanwaljeet Singla, Seattle, WA (US); Mete Goktepe, Redmond, WA (US); Michael E. Brown, Issaquah, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/552,923

(22) Filed: Oct. 25, 2006

(51) Int. Cl. G06F 9/44

(52) U.S. Cl. 717/120

(57) ABSTRACT

In one embodiment of this invention, a computer system performs a method for validating a software build before check-in. A computer system accesses an existing software build of a software application that includes one or more existing binary files. The computer system accesses one or more updated binary files from a computer user. The computer system overwrites appropriate existing binary files in the existing software build with corresponding updated binary files for the updated binary files package. The overwriting included incorporating the updated binary files into the existing build of the software application without having to generate a new build of the software application. The computer system evaluates the functionality of the updated existing software build, wherein evaluating includes determining whether at least the updated binary files satisfy a threshold level of functionality. The computer system generates a report representing the results of the functionality evaluation.

### BACKGROUND

Computers are used all over the world to accomplish a variety of tasks. Computers accomplish tasks by processing sets of instructions derived from software source code. Software source code is typically written by a software developer using one or more programming languages. Most programming languages have a software source code compiler that allows the code to be compiled into one or more data files. Such data files may be used in conjunction with other data files to form a software application. As such, software applications can be viewed as conglomerates of data files, where each data file may be initiated by the user or by the software application to perform, or assist in performing a task.

During the software code development process, software developers often make multiple revisions to the software source code. Each time the code is revised and re-compiled, a new version of the data file is created. Large software applications may have thousands of files, each of which may be revised and re-compiled during the development process. Because of the complex interactions of data files within an application, the application must be thoroughly tested to ensure that the intended functionality is working as expected.

To test a software application, a software build is typically created by combining the updated, compiled files checked-in by each developer. After the build is created, test computers are used to run the build, initializing common tasks within that application. However, in some cases, application developers may forget to include one or more files or parts of files. This, in turn, affects other files that rely on the missing files or file parts. In such cases, the build is said to be “broken” and cannot be properly tested. The build process must then be reinitiated. In some cases, it may take multiple hours to receive updated files from each developer and additionally time thereafter to create a new build.

Other scenarios (apart from forgetting to include a file in a build) can also cause a software build to break. For instance, if a developer incorporates untested files into the build and one or more of the untested files is either incomplete or is functioning improperly, the entire build may be crippled or completely broken. There are a number of reasons why untested files may be checked-in to the official build: the developer might not have had sufficient time, there may have been no test computers available, the available test computers may have had the wrong operating system installed (e.g. Windows™, Linux, etc.) or the wrong processor architecture (e.g. X86, X64, AMD64, etc.). Furthermore, even if all of the updated files checked in by the developer function properly on the developer's test computers, oftentimes interactions with updated files from other developers can cause conflicts and create errors that cause the build to break.

Such build problems are, of course, unproductive and costly. In some cases, developers and testers may wait hours or days to get a new, fully functional build. Software producers have tried various tactics to decrease the number of build breaks. For example, in some cases software developer teams have been given their own virtual build labs where they can create and test their updated files in a virtual build before submitting them for the next official build. Other mechanisms include as nightly builds and/or build validation tests which have been used to help cut down on build breaks. Despite such solutions, build problems are still common among software producers.

### BRIEF SUMMARY

Embodiments of the present invention are directed to systems and methods for validating a software build before check-in. In one embodiment of this invention, a computer system performs a method for validating a software build before check-in. A computer system accesses an existing software build of a software application, that includes one or more existing binary files. The computer system accesses one or more updated binary files from a computer user. The updated binary files are updated versions of the one or more existing binary files. The computer system overwrites appropriate existing binary files in the existing software build with corresponding updated binary files for the updated binary files package. The overwriting includes incorporating the updated binary files into the existing build of the software application without having to generate a new build of the software application. The computer system evaluates the functionality of the updated existing software build that includes the updated binary files, wherein evaluating includes determining whether at least the updated binary files satisfy a threshold level of functionality. The computer system generates a report representing the results of the functionality evaluation, wherein the results indicate whether the received updated binary files satisfied the threshold level of functionality.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a computing environment in which embodiments of the present invention may operate including validating a software build before check-in;

FIG. 2 illustrates a flowchart of an example method for validating a software build before check-in;

FIG. 3 illustrates an embodiment of a graphical user interface configurable to allow a user to select one or more binary file update evaluation settings; and

FIG. 4 illustrates a flowchart of an example method for validating a software build before check-in.

### DETAILED DESCRIPTION

Embodiments of the present invention are directed to systems and methods for validating a software build before check-in. In one embodiment of this invention, a computer system performs a method for validating a software build before check-in. A computer system accesses an existing software build of a software application, that includes one or more existing binary files. The computer system accesses one or more updated binary files from a computer user. The updated binary files are updated versions of the one or more existing binary files. The computer system overwrites appropriate existing binary files in the existing software build with corresponding updated binary files for the updated binary files package. The overwriting included incorporating the updated binary files into the existing build of the software application without having to generate a new build of the software application. The computer system evaluates the functionality of the updated existing software build that includes the updated binary files, wherein evaluating includes determining whether at least the updated binary files satisfy a threshold level of functionality. The computer system generates a report representing the results of the functionality evaluation, wherein the results indicate whether the received updated binary files satisfied the threshold level of functionality. The embodiments of the present invention may comprise a special purpose or general-purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

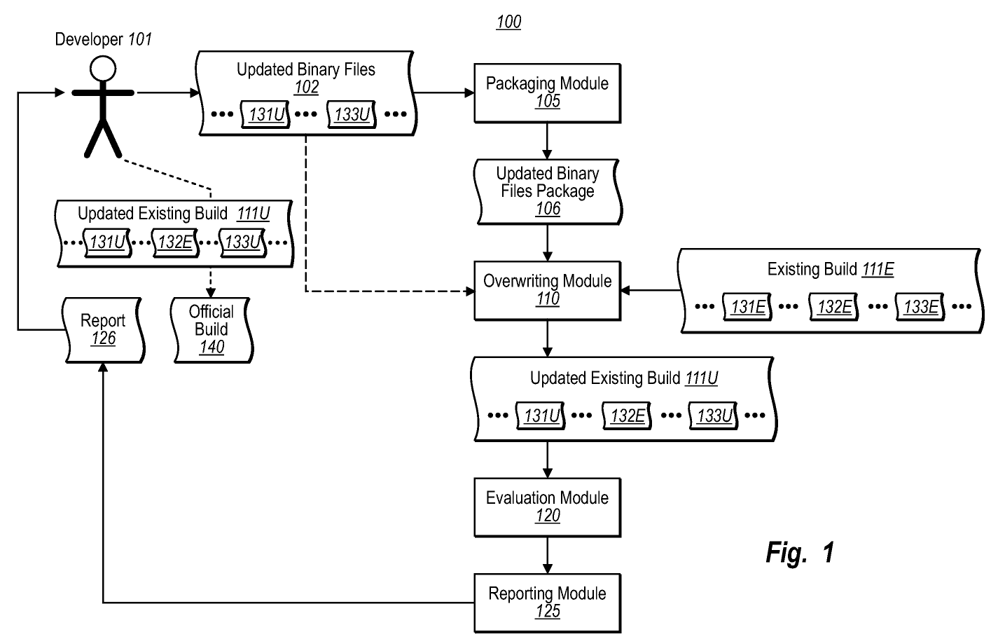

FIG. 1 illustrates an environment 100 (e.g. a computer architecture) in which the principles of the present invention may be employed. Environment 100 as includes software developer 101. Software developers are typically computer users who write code to develop at least a portion of a software application. As used herein, a software developer (e.g., developer 101) may be any type of computer user, or more specifically, a software programmer who periodically generates updated binary files for the application he or she is developing. Binary files are files which have been compiled from the source code written by the developer (e.g., developer 101). Developers can test their binary files by combining them together into a software build and then running the software build through test scenarios. Generally, test scenarios are designed to test the most commonly used functionality of the software application. Thus, in some embodiments, developer 101 may initiate the testing process by sending updated binary files 102 to packaging module 105.

Updated binary files 102 can include one or more updated binary files (e.g., updated binary files 131U, 133U, etc.) that are to overwrite corresponding existing binary files in an existing software build (e.g., existing build 111E). For example, developer 101 can modify (update) the existing source code used to generate existing binary file 131E and then subsequently compile the modified (updated) source to generate updated binary file 131U.

In some embodiments, packaging module 105 is capable of receiving updated binary files (e.g., updated binary files 102) and packaging the files into a package (e.g. updated binary files package 106). An updated binary files package (e.g., updated binary files package 106) can include those binary files that developer 101 has (potentially recently) updated. For example, it may be that during the development process, a developer updates a portion of the total files necessary to run the application. Thus, many binary files may not change from one build to the next. In some cases, it may be advantageous to test the updated binary files to ensure that as these updated files do not hinder or break the functionality of other existing files that may rely on the updated files. Thus, in some embodiments, updated binary files package 106 may be combined with existing build 111 for evaluation.

In some embodiments, overwriting module 110 is configured to receive updated binary files package 106 and existing build 111. In other embodiments, overwriting module 110 is configured to receive updated binary files 102 and existing build 111. In either event, existing build 111 may include one or more binary files for the application the developer is developing. In some embodiments, existing build 111 may contain the latest version of each of the application's binary files. Thus, the evaluation may test the updated binary files along with the most up-to-date versions of the non-updated binary files. In some cases, however, it may be possible for a developer to choose a previous build of the software application (e.g. a build that does not contain the most up-to-date versions of the binary files). Such a situation may occur when a build is found to be broken and the developer wishes to test the updated binary files combined with the last known working build.

Overwriting module 110 can overwrite (through binary replacement) any binary files in existing build 111 that are updated in updated binary files package 106 and/or updated binary files 102. In some embodiments, the result of the overwriting is updated existing build 111U. For example, updated existing build 111U may include updated binary files 131U and 133U as well as existing binary file 132E. In FIG. 1, updated existing build 111U is illustrated as having two updated binary files (131U and 133U) and one existing binary file (132E). It should be understood that the illustration is merely exemplary and that updated existing build 111U may contain any number or combination of existing and/or updated binary files. Overwriting can be performed without the need to generate a new build. Updated existing build 111U as may be sent to evaluation module 120 for evaluation.

Evaluation module 120 can be configured to perform functionality evaluations of software builds. For example, evaluation module 120 may receive updated existing build 111U containing updated binary files 102, to perform a functionality evaluation thereon. Functionality evaluations may include test scenarios that initiate and run through the application's processes.

For example, developer 101 may be working on a spreadsheet application. Developer 101 may send updated versions of the binary files to packaging module 105 where the files are packaged into updated binary files package 105. Overwriting module 110 may then take an existing build (e.g., build 111E) of the spreadsheet application and overwrite all the files in the build that are updated by updated binary files package 106. Existing build 111E combined with updated binary files package 106 (or, alternatively updated binary files 102) of the spreadsheet application may then be evaluated by evaluation module 120. In some cases, evaluation module 120 may run anywhere from one to all of the spreadsheet application's processes, thus implementing anywhere from one to all of the spreadsheet application's binary files. Evaluation module 120 may then make a determination for each process which binary files worked and which did not.

For example, developer 101 may desire to know which processes completed as expected and which processes were never executed or were executed with limited success. Reporting module 125 of environment 100 may track the results of each functionality evaluation and include these results in report 126. Thus, in some embodiments, report 126 may include the pass or fail result for each process, function or individual file. Reporting module 125 may, for instance, keep track of each file that was used and whether the process that used those files completed successfully. In cases where the process fails before completion, reporting module 125 may include in report 126 where the process failed. Specifically, reporting module 125 may include which file or files caused the process to fail. Thus, within environment 100, the functionality of a developer's updated binary files may be validated before the files are checked in to department- or company-wide build.

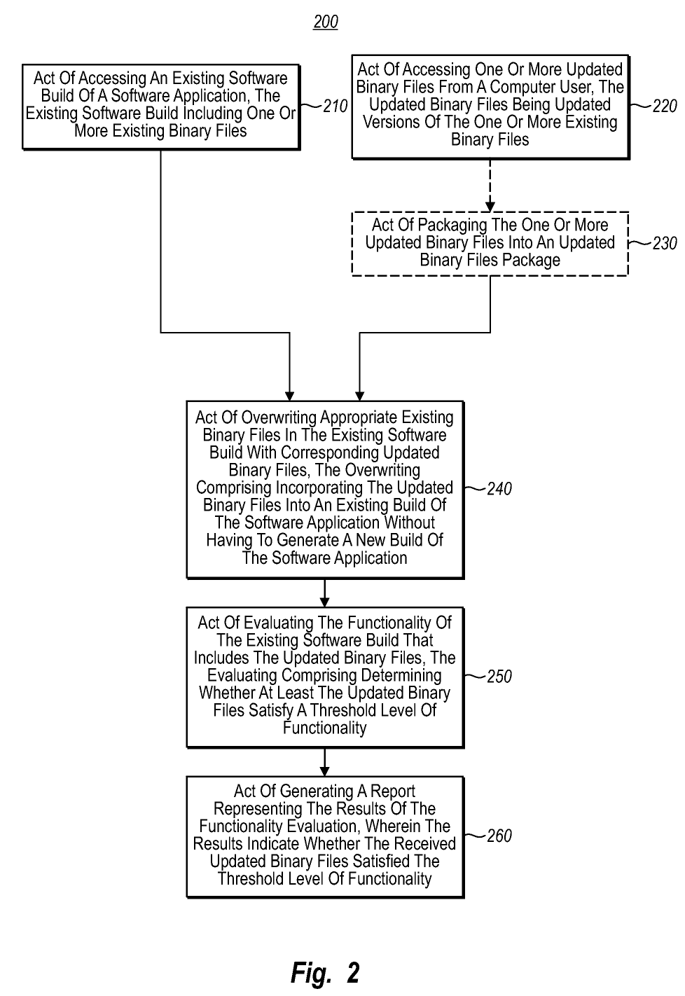

FIG. 2 illustrates a flowchart of a method 200 for validating a software build before check-in. The method 200 will now be described with frequent reference to the components and data of environment 100.

Method 200 includes an act of accessing an existing software build of a software application, the existing software build including one or more existing binary files (act 210). For example, a computer system may access existing software build 111E, where build 111E includes one or more existing binary files. In some embodiments, existing build 111E may include the latest version of one or more existing files (e.g., 131E, 132E, etc.), or alternatively, build 111E may include past versions of one or more existing binary files.

Method 200 includes an act of accessing one or more updated binary files from a computer user, the updated binary files being updated versions of the one or more existing binary files (act 220). For example, packaging module 105 may receive updated binary files 102 from developer 101. Alternatively, the overwriting module 110 may receive updated binary files 102 from developer 101. In some embodiments, during the process of developing an application, developer 101 may update binary files for the application currently under development. These updated binary files 102 may be sent to packaging module 105 to be packaged together, or may be sent directly as to overwriting module 110. As explained above, binary files are compiled from the corresponding source code written by the developer. In some embodiments, updated binary files 102 include those binary files that have been changed or updated since the last build of the software application. In some cases, developer 101 may send updated binary files 102 to packaging module 105 via a terminal services connection. For example, developer 101 may be connected to packaging module 105 and/or overwriting module 110 via a terminal services connection and thereby transmit updated binary files 102 to either of packaging module 105 or overwriting module 110.

Method 200 includes an optional act of packaging the one or more updated binary files into an updated binary files package (act 230). For example, packaging module 105 may package updated binary files 102 into updated binary files package 106. In some embodiments, updated binary files package 106 contains those binary files that have been modified or updated since the last build of the software application.

Method 200 includes an act of overwriting appropriate existing binary files in the existing software build with corresponding updated binary files for the updated binary files package, the overwriting comprising incorporating the updated binary files package into an existing build of the software application without having to generate a new build of the software application (act 240). For example, overwriting module 110 may overwrite (e.g., through binary replacement) appropriate existing binary files in existing software build 111E with updated binary files package 106 (or, alternatively, updated binary files 102), where the overwriting includes incorporating updated binary files package 106 (or updated binary files 102) into existing build 111E without having to generate a new build of the software application. For example, overwriting module 110 may overwrite files 131E and 133E in existing build 111E with corresponding updated binary files 131U and 133U. In this example, 132E would not be overwritten because, in this case, file 132E was not updated. In this manner, updated files 102 (or updated binary files package 106) can be incorporated into existing build 111E without having to generate a new build of the software application.

In some embodiments, overwriting module 110 may receive both existing build 111E and either updated binary files package 106 (or updated binary files 102). Overwriting module may overwrite those files in the existing build that are updated or are newer in updated binary files package 106 (or updated binary files 102). As explained above, existing build 111E may include the latest version of each binary file for the application. Or, alternatively, existing build 111E may include the last known version of each file that was fully functional. For example, many times in the development process, instead of testing against the latest build, developers choose to test the newly updated files as combined with a set of known working files. In this manner, the developer may be able to more quickly ascertain that any problems with the build originated from the newly updated binary files.

Method 200 includes an act of evaluating the functionality of the existing software build that includes the updated binary files, the evaluating comprising determining whether at least the updated binary files satisfy a threshold level of functionality (act 250). For example, evaluation module 120 may evaluate the functionality of updated existing build 111U (which includes updated binary files 102), where the evaluation includes determining whether at least the updated binary files (e.g., 131U and 133U) satisfy a threshold level of functionality.

In some embodiments, the threshold level of functionality represents a level of functionality such that a build validation test could be completed substantially without errors. In some cases, during the development process, developers may run build validation tests to test their new source code (i.e. updated binary files 102). Often, build validation tests are used to determine whether the basic functions of the application work (e.g. the application installs, opens, and performs major functions properly). Typically, build validation tests do not test all of the functionality in the software application. This is primarily because the tests are meant to be performed quicker than a full build test. In cases where the threshold level of functionality was such that a build validation test should complete substantially without errors, if there were no or substantially few errors, then the threshold would be met and the build validation test would be said to have passed.

Similarly, in some embodiments, the threshold level of functionality may represent a level of functionality such that a build of the software application could be executed substantially without errors. In such a case, if a build of a software application was executed substantially without errors, the threshold would be satisfied and the build would be said to have passed. A build test can test the functionality of substantially all the functions in a software application. However, depending on the complexity of the software application, it may be possible to thoroughly test portions of the application in the build test. In some cases, the build test may test each application file individually and in combination with other application files within the build. Due to the nature of software testing and the differing complexities of software applications, build tests and build verification tests may be adapted and modified to test those functions deemed important for testing by the application developer or other individual responsible for quality assurance.

Method 200 includes an act of generating a report representing the results of the functionality evaluation, wherein the results indicate whether the received updated binary files satisfied the threshold level of functionality (act 250). For example, reporting module 125 may generate report 126 representing the results of the functionality evaluation, where the results indicate whether updated binary files 102 satisfied the threshold level of functionality. In some embodiments, the report comprises a log file representing the pass or fail result for each binary file evaluated. The log file may also include other items of information such as the time each file or function was tested, which binary files were used, which files from existing build 111 were used in conjunction with updated binary files 102, or other items of information helpful to the developer.

In some cases, report 126 may be automatically sent to the computer user in electronic form upon completion of the software build evaluation. In some embodiments, an email may be sent with the report contained in the body of the email or as an attached file. Additionally or alternatively, the results of the evaluation may be automatically stored in a database. The database may include any type of database and may be accessed locally or remotely.

In some embodiments, method 200 may also include an act of scheduling the initiation of tasks on one or more software build evaluation resources. For example, developer 101 may desire to run the evaluation on resources (e.g. computer test lab A) that are currently in use. In such a case, it may be advantageous for developer 101 to schedule any desired tasks and allow a scheduler (e.g. a computer which controls evaluation resources) to later initiate the desired tasks on the resource. Computer test labs can include any number of computers configured to perform software build evaluations, which may be communicatively connected via a network, or may be isolated, individual computers. Each computer in a test lab may be configured differently (e.g. different operating systems, different processor architectures (e.g. x86, IA-32, x64, IA-64, AMD64, RISC, etc.) different hardware, different hardware settings, etc.) or, alternatively, each computer may be configured substantially the same.

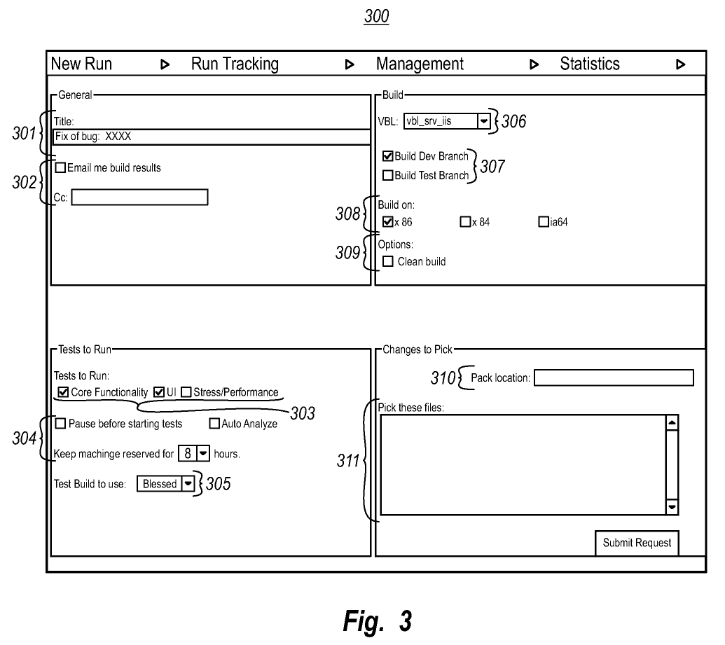

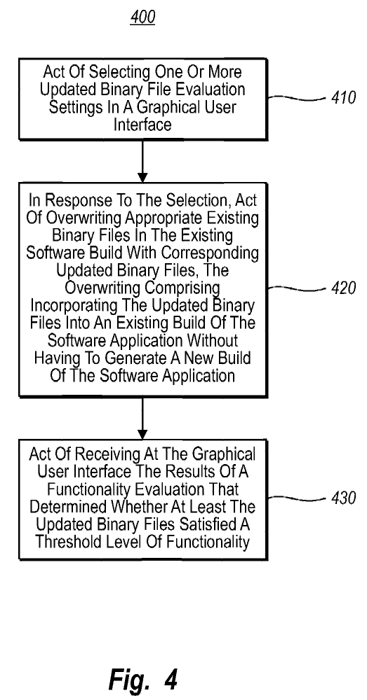

In some embodiments, a computer user may use a graphical user interface (as illustrated in FIG. 3) to select at least one of: which evaluations to run, which evaluation lab to use, which development branch to use, which operating system to use, which processor architecture to use, which updated binary files package to use, the title of the updated binary files package, whom to notify of the evaluation results, how long to wait before beginning the evaluation, how long to reserve the evaluation lab, and which existing software build to use in the evaluation. For example, developer 101 may use a graphical user interface (GUI) similar to the GUI illustrated in FIG. 4 to select various settings to be used in the evaluation of updated binary files 102. Developer 101 may choose which evaluations to run (e.g. a web test, a user interface test, or a stress test), which evaluation lab to use (e.g. a lab with a certain operating system installed, certain hardware, a certain number of test computers, etc.), which development branch to use (e.g. testing or development), which operating system to use, which processor architecture to use, which updated binary files package to use (e.g. the latest package or an older, perhaps known working package), the title of the updated binary files package, whom to notify of the results, and which existing software build to use. In some cases, the GUI is accessed via an internet browser application.

FIG. 3 illustrates an embodiment of a graphical user interface configurable to allow a user to select one or more binary file update evaluation as settings. FIG. 4 illustrates a flowchart of an example method for validating a software build before check-in. The method 400 will now be described with frequent reference to the components and data of environment 100 and graphical user interface 300.

Method 400 includes an act of selecting one or more updated binary file evaluation settings in a graphical user interface (act 410). For example, developer 101 may select one or more updated binary file evaluation settings in GUI 300. As explained above, in some embodiments, GUI 300 may be accessed via an internet browser application. In such cases, developer 101 may be able to schedule and run evaluations of updated binary files 102 from any location with internet access.

In some embodiments, GUI 300 includes one or more options for selecting evaluation settings. For example, GUI 300 may include a title field 301 wherein a computer user (e.g., developer 101) may name the title for the evaluation. GUI 300 may also include selectable notification options 302 that determine who will be notified of the evaluation results. As illustrated in 302, the user of GUI 300 may be notified by checking the “Email me build results” box. Similarly, by entering names, email aliases, or other identifiers into the “Cc” field, other individuals may be notified of the evaluation results.

GUI 300 may also include selectable tests 303 which may be run during the evaluation. For example, selectable tests 303 may include “Webtest” (which may include core application functionality), “Nexus/UI” (which may include tests more heavily adapted to evaluating the user interface), and “Stress” (which may include tests geared to large-scale integration or other stress tests). Other elements in GUI 300 may include selectable test options 304 such as “Pause before starting tests,” “Auto Analyze,” and “Keep machine reserved for X [number of] hours.” In some instances, it may be advantageous to pause and wait for user input before running the evaluations. Furthermore, it may be advantageous to perform some type of automatic analysis during the evaluation and/or of the evaluation results. Reserving the test machines may also be beneficial to ensure that the test computers will be available. Also, GUI 300 may include a field for selecting which test build (e.g., existing build 111E) to use (305). In some embodiments, multiple versions of a build may exist and may be selectable by the computer user for the evaluation.

In some embodiments, GUI 300 may include a field for selecting which build lab to use for the evaluation 306. Where multiple build labs exist, a drop-down list may be used to select the appropriate lab for the evaluation. Element 307 includes an option to select which build branch to use (e.g., “Build Dev Branch” or “Build Test Branch” depending on the desired type and depth of evaluation). GUI 300 may include an option for selecting which processor architecture to use during the evaluation 308. Possible architectures may include x86, x64, ia64, and others. GUI 300 may also have an option for selecting other build options 309 such as what type of build to use (e.g., a clean build).

In some embodiments, GUI 300 may include an option for selecting the location of an updated binary files package (e.g., updated binary files package 106) 310. Guild 300 may also include a field for inputting individual updated files (e.g., updated binary files 102) 311. These updated binary files (or their locations) may be inputted into field 311 in addition to any inputted updated binary files packages in 310 or may be entered alternative to entering an updated binary files package in 310.

Method 400 includes, in response to the selection, an act of overwriting appropriate existing binary files in the existing software build with corresponding as updated binary files from the updated binary files package, the overwriting comprising incorporating the updated binary files package into an existing build of the software application without having to generate a new build of the software application (act 420). For example, in response to a selection by developer 101, overwriting module 110 may overwrite appropriate existing binary files in existing software build 111E with updated binary files package 106, where the overwriting includes incorporating updated binary files package 106 (or updated binary files 102) into existing build 111E without having to generate a new build of the software application. Updated existing build 111U may be evaluated by evaluation module 120 and the results thereof may be reported by reporting module 125, as explained above.

Method 400 includes an act of receiving at the graphical user interface the results of a functionality evaluation that determined whether at least the updated binary files satisfied a threshold level of functionality (act 430). For example, GUI 300 may receive and provide access to report 126 which includes the results of a functionality evaluation that determined whether at least updated binary files 102 satisfied a threshold level of functionality. As explained above, the threshold level of functionality may be such that a build validation test could be completed substantially without errors. Additionally or alternatively, the threshold level of functionality may be such that a build of the software application could be executed substantially without errors.

Similarly, in some embodiments, a computer user may use GUI 300 to select at least one of: which evaluations to run, which evaluation lab to use, which development branch to use, which operating system to use, which processor architecture to use, which updated binary files package to use, the title of the updated binary files package, whom to notify of the evaluation results, how long to wait before as beginning the evaluation, how long to reserve the evaluation lab, and which existing software build to use in the evaluation. It should be noted that other functionality not listed above may be implemented in GUI 300 to give the computer user (e.g., developer 101) more control over how the updated binary files are evaluated. In this manner, developer 101 may be able to update the binary files for the software application he or she is working on, select those updated files for evaluation using the GUI, and receive results of the evaluation within a relatively short amount of time. Thus, a developer may know, prior to checking in the updated binary files into a department- or company-wide build, whether or not the updated binary files satisfy a threshold level of functionality.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system configured to process binary files, a method for validating one or more binary files of a software application before the binary files are checked-in for incorporation into an existing software build, the method comprising:
an act of accessing an existing software build of a software application, the existing software build including one or more existing binary files;
an act of accessing one or more updated binary files from a computer user, the updated binary files being updated versions of the one or more existing binary files;
an act of overwriting appropriate existing binary files in the existing software build with corresponding updated binary files, the overwriting comprising incorporating the updated binary files into an existing build of the software application without having to generate a new build of the software application;
an act of evaluating the functionality of the updated existing software build that includes the updated binary files, the evaluating comprising determining whether at least the updated binary files satisfy a threshold level of functionality; and
an act of generating a report representing the results of the functionality evaluation, wherein the results indicate whether the received updated binary files satisfied the threshold level of functionality.

2. The method of claim 1, further comprising an act of scheduling the initiation of tasks on one or more software build evaluation resources.

3. The method of claim 2, wherein the one or more software build evaluation resources comprises an evaluation lab containing one or more computer systems configured to perform software build evaluations.

4. The method of claim 3, wherein the computer user uses a graphical user interface to select at least one of: which evaluations to run, which evaluation lab to use, which development branch to use, which operating system to use, which processor architecture to use, which updated binary files package to use, the title of the updated binary files package, whom to notify of the evaluation results, how long to wait before beginning the evaluation, how long to reserve the evaluation lab, and which existing software build to use in the evaluation.

5. The method of claim 4, wherein processor architecture types include x86, IA-32, x64, IA-64, AMD64, RISC or any other type of processor architecture.

6. The method of claim 4, wherein the graphical user interface is accessed via an internet browser application.

7. The method of claim 1, wherein the report comprises a log file representing the pass or fail result for each binary file evaluated.

8. The method of claim 1, wherein the report is automatically sent to the computer user in electronic form upon completion of the software build evaluation.

9. The method of claim 1, wherein the results of the evaluation are automatically stored in a database.

10. The method of claim 1, wherein the computer user sends the one or more updated binary files to the computer system via a terminal services connection.

11. The method of claim 1, wherein the threshold level of functionality represents a level of functionality such that a build validation test could be completed substantially without errors.

12. The method of claim 1, wherein the threshold level of functionality represents a level of functionality such that a build of the software application could be executed substantially without errors.

13. The method of claim 1, wherein the existing build of the software application comprises the latest version of each binary file within the build.

14. The method of claim 1, wherein each application file is evaluated alone and in combination with other binary files within the build.

15. A computer program product comprising one or more computer-readable media having thereon computer-executable instructions that, when executed by one or more processors of a computing system, cause the computing system to perform a method for validating one or more binary files of a software application before the binary files are checked-in for incorporation into an existing software build, the method comprising:
an act of receiving one or more updated binary files from a computer user;
an act of packaging the one or more updated binary files into an updated binary files package;
an act of overwriting appropriate existing binary files in the existing software build with corresponding updated binary files for the updated binary files package, the overwriting comprising incorporating the updated binary files package into an existing build of the software application without having to generate a new build of the software application;
an act of evaluating the functionality of the existing software build that includes the updated binary files, the evaluating comprising determining whether at least the updated binary files satisfy a threshold level of functionality; and
an act of generating a report representing the results of the functionality evaluation, wherein the results indicate whether the received updated binary files satisfied the threshold level of functionality.

16. The method of claim 15, wherein the results of the evaluation are automatically stored in a database.

17. The method of claim 15, wherein the threshold level of functionality represents a level of functionality such that a build of the software application could be executed substantially without errors.

18. At a computer system configured to process binary files, a method for selecting an updated binary file evaluation to validate one or more updated binary files of a software application before the updated binary files are checked-in for incorporation into an existing software build, the method comprising:
an act of selecting one or more updated binary file evaluation settings in a graphical user interface;
in response to the selection, an act of overwriting appropriate existing binary files in the existing software build with corresponding updated binary files, the overwriting comprising incorporating the updated binary files into an existing build of the software application without having to generate a new build of the software application; and
an act of receiving at the graphical user interface the results of a functionality evaluation that determined whether at least the updated binary files satisfied a threshold level of functionality.

19. The method of claim 18, wherein the selection includes at least one of: which evaluations to run, which evaluation lab to use, which development branch to use, which operating system to use, which processor architecture to use, which updated binary files package to use, the title of the updated binary files package, as whom to notify of the evaluation results, how long to wait before beginning the evaluation, how long to reserve the evaluation lab, and which existing software build to use in the evaluation.

20. The method of claim 19, wherein the graphical user interface is accessed via an internet browser application.
